(19) United States
(12) Patent Application Publication
(10) Pub. No.: US 2016/0117672 A1
(43) Pub. Date: Apr. 28, 2016

(54) ELECTRONIC CREDITING OF AN ACCOUNT LINKED TO A PAYMENT DEVICE

(71) Applicant: MASTERCARD ASIA PACIFIC PTE LTD., Singapore (SG)

(72) Inventors: Christabel TAN, Singapore (SG); Julienne LOH, Singapore (SG); Tan Sock HOON, Singapore (SG)

(73) Assignee: MASTERCARD ASIA PACIFIC PTE LTD., Singapore (SG)

(21) Appl. No.: 14/920,297

(22) Filed: Oct. 22, 2015

(30) Foreign Application Priority Data
Oct. 23, 2014 (SG) 10201406886R

(51) Int. Cl. G06Q 20/38; G06Q 20/36; G06Q 20/34

(52) U.S. Cl. CPC G06Q 20/381; G06Q 20/34; G06Q 20/363

(57) ABSTRACT

According to one aspect of the invention, there is provided a method of remotely electronically crediting an account linked to a payment device, the method comprising: placing the payment device, which is linked to the account, in communication with a computing terminal; determining in the computing terminal, the account to be credited from data stored on the payment device; indicating, to the computing terminal, an amount to credit the account, wherein the amount is in a different currency from a currency assigned to the account; receiving the amount in the different currency; converting, in a server, the amount in the different currency into the currency assigned to the account; and crediting the account with the amount in the currency assigned to the account. A server and a computing terminal that facilitates this remote electronic crediting of this account are also disclosed.

### TECHNICAL FIELD

The following discloses method, server and computer terminal arrangements for electronic crediting of an account linked to a payment device.

### BACKGROUND

Payment cardholders upon travelling overseas will often have left over cash in a currency where they have traveled. In a bid to fully expend all their foreign currency, such cardholders may spend their remaining foreign currency on frivolous items at, for example, the airport before departure. If the remaining foreign currency is not spent, it would be brought home and accumulate.

Cardholders will not be able to use these currencies until they travel out to the same countries again. If the cardholders do not regularly travel to these countries, the accumulated foreign currency may become forgotten or misplaced. Some of these foreign currencies also become out of circulation over time. (e.g. French franc) and getting such currency changed to those that are presently in circulation may be a tedious task.

There is thus a need to find a means to address the issue of having left over foreign currency when travelling overseas.

### SUMMARY

According to a first aspect of the invention, there is provided a method of remotely electronically crediting an account linked to a payment device, the method comprising: placing the payment device, which is linked to the account, in communication with a computing terminal; determining in the computing terminal, the account to be credited from data stored on the payment device; indicating, to the computing terminal, an amount to credit the account, wherein the amount is in a different currency from a currency assigned to the account; receiving the amount in the different currency; converting, in a server, the amount in the different currency into the currency assigned to the account; and crediting the account with the amount in the currency assigned to the account.

According to a second aspect of the invention, there is provided a server for an intermediary that facilitates crediting of an account linked to a payment device when remote electronic crediting of the account is initiated, the server comprising: at least one processor; and at least one memory including computer program code; the at least one memory and the computer program code configured to, with the at least one processor, cause the server at least to: determine the account to be credited from data stored on the payment device which is linked to the account; receive data indicative of an amount to credit the account, wherein the amount is in a different currency from a currency assigned to the account; obtain an indication of the amount converted in the currency assigned to the account; and provide the account with the indication of the amount converted in the currency assigned to the account to be credited into the account.

According to a third aspect of the invention, there is provided a method of electronically crediting an account linked to a payment device, the method comprising: receiving from a computing terminal data indicating the account to be credited from data stored on the payment device which is linked to the account; receiving from the computing terminal, an indication of an amount to credit the account, wherein the amount is in a different currency from a currency assigned to the account; converting the amount in the different currency into an amount in the currency assigned to the account; and crediting the account with the amount in the currency assigned to the account.

According to a fourth aspect of the invention, there is provided a computing terminal for remotely electronically crediting an account linked to a payment device, the computing terminal comprising: at least one processor; and at least one memory including computer program code; the at least one memory and the computer program code configured to, with the at least one processor, cause the computing terminal at least to: detect that the payment device, which is linked to the account, is placed in communication with the computing terminal; determine the account to be credited from data stored on the payment device; and receive an indication of an amount to credit the account, wherein the amount is in a different currency from a currency assigned to the account; and transmit data indicative of the received amount for conversion into the currency assigned to the account and subsequent crediting into the account.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIGS. 1A to 1E show a schematic of a system in which electronic crediting of an account linked to a payment device may be performed. Each of FIGS. 1A to 1E shows a stage of the electronic crediting process.

FIG. 2 shows a flowchart depicting steps of a method that occurs in the system of FIGS. 1A to 1E during electronic crediting of an account linked to a payment device.

FIG. 3 shows an exemplary computing device to realize a server for the intermediary shown in FIGS. 1A to 1E.

FIGS. 4A and 4B each show a schematic of a server for the intermediary shown in the system of FIGS. 1A to 1E. FIG. 4C shows a method that is performed by the server for the intermediary shown in FIGS. 4A and 4B.

FIG. 5 is a schematic of an exemplary computing device that may be utilized to implement the computing terminal shown in FIGS. 1A to 1E.

FIGS. 6A to 6D each illustrate a sequence that may be followed during electronic crediting of an account linked to a payment device.

### DETAILED DESCRIPTION

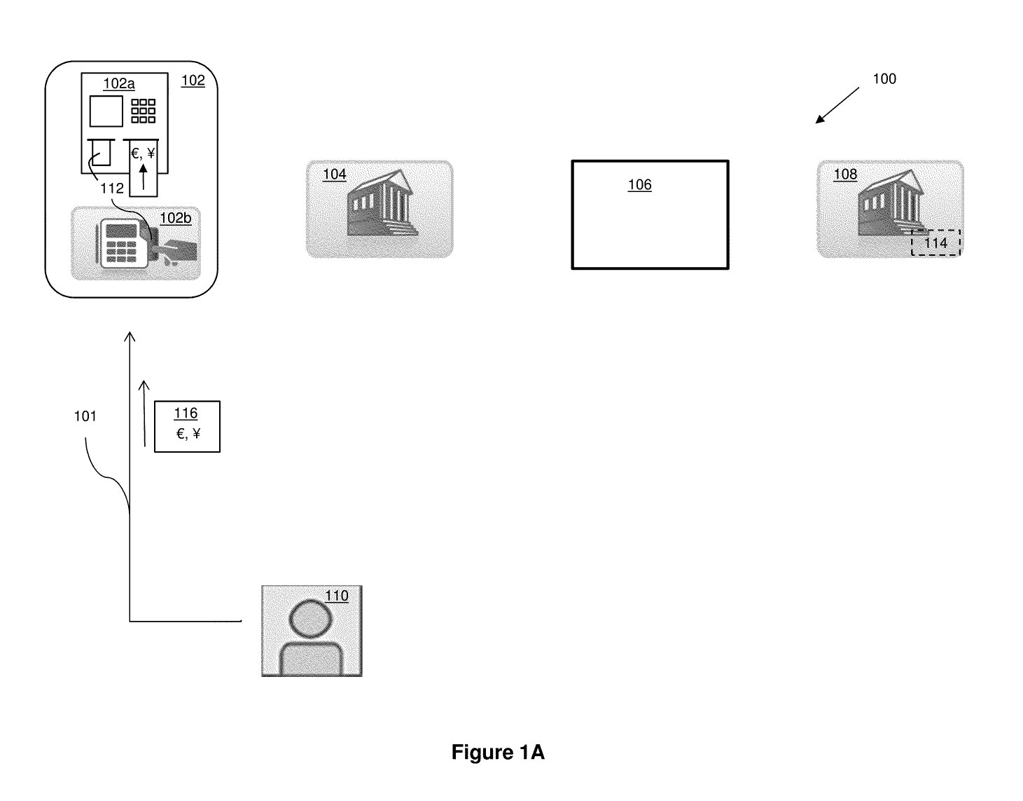

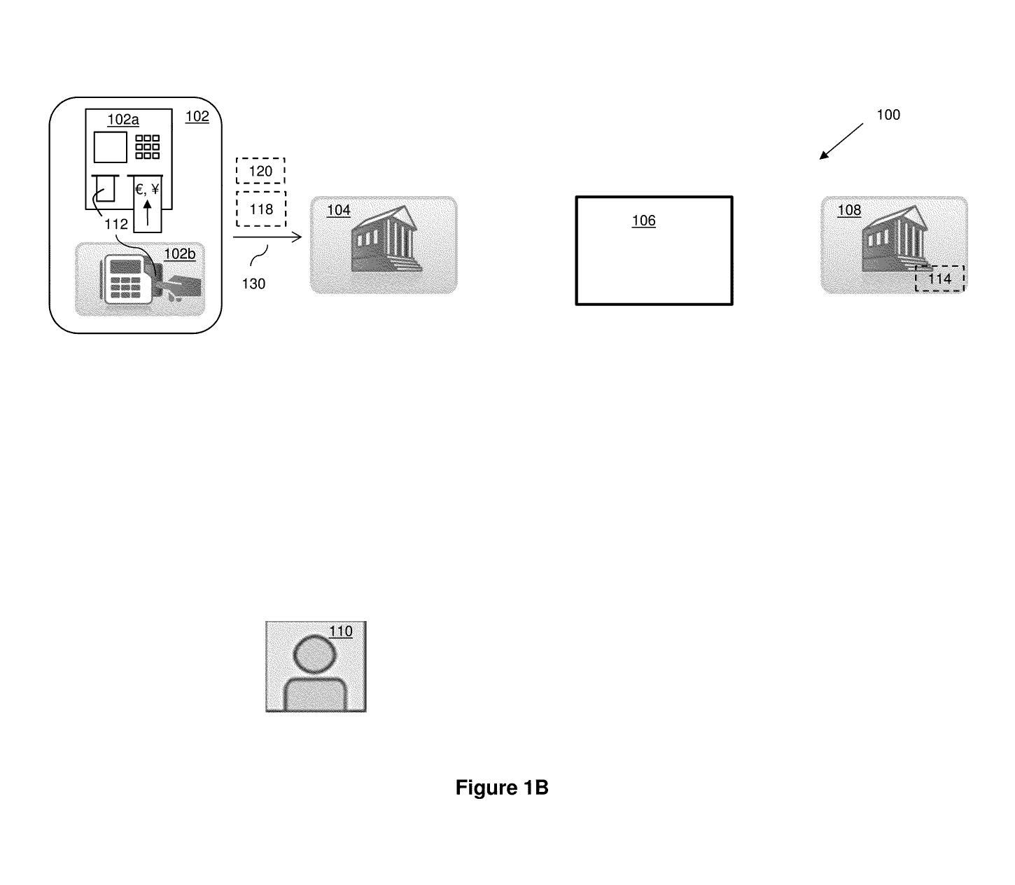

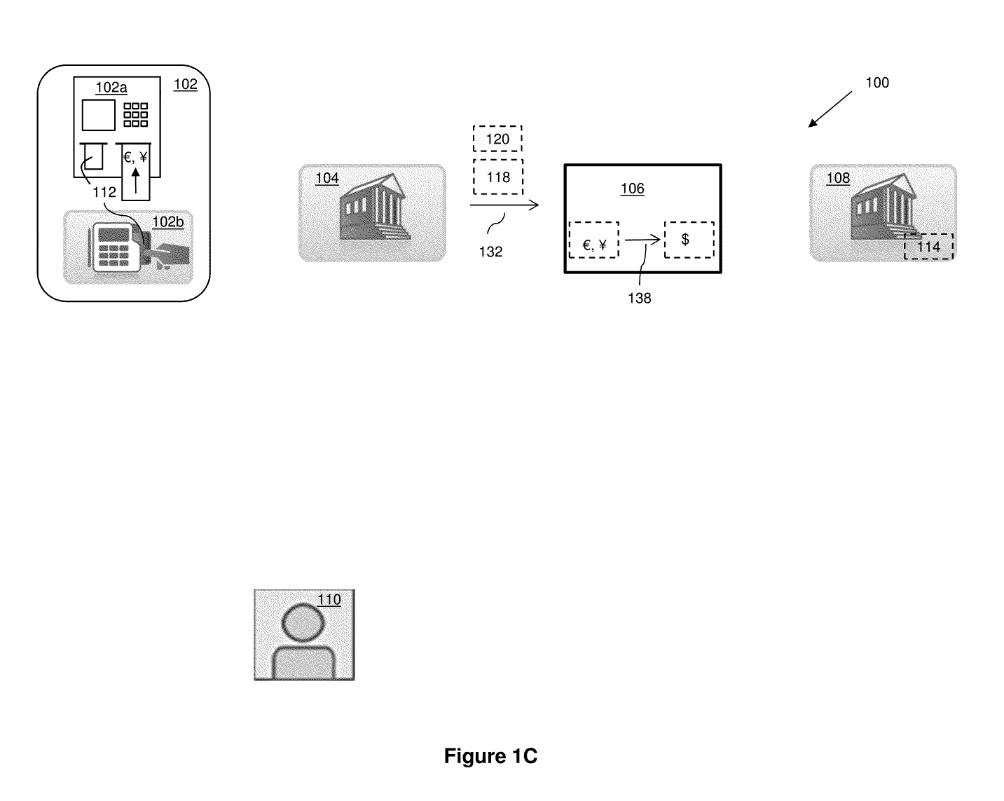

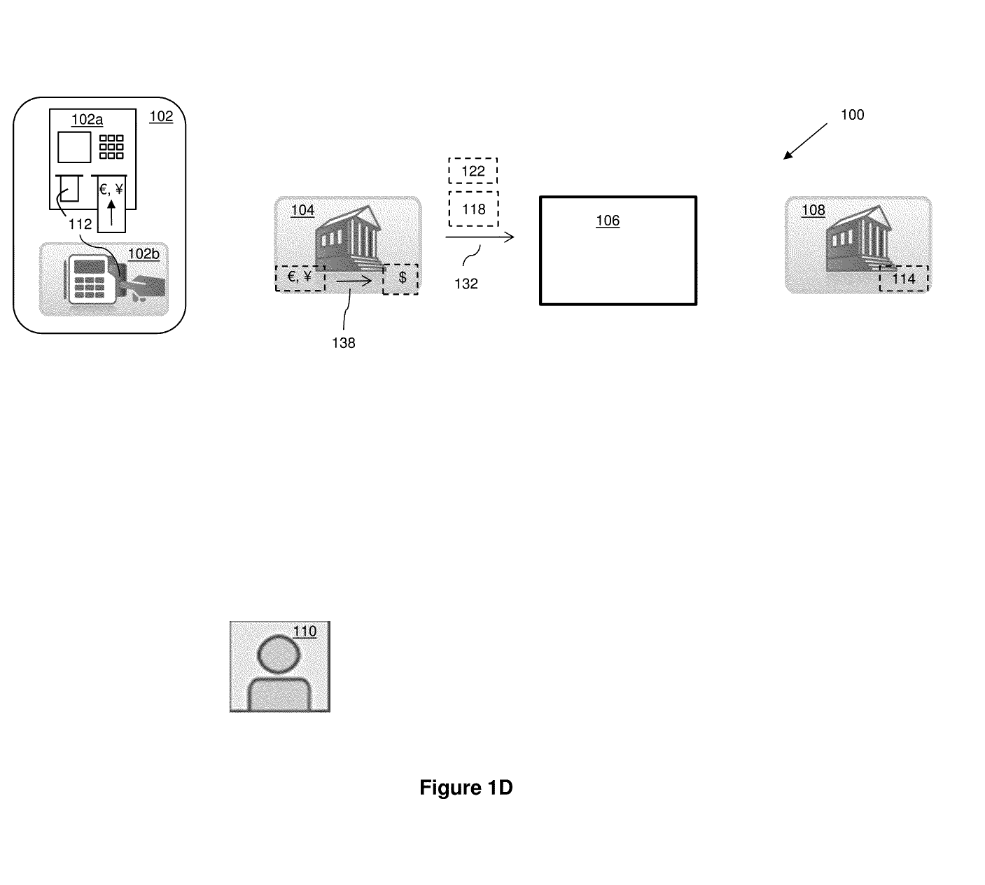

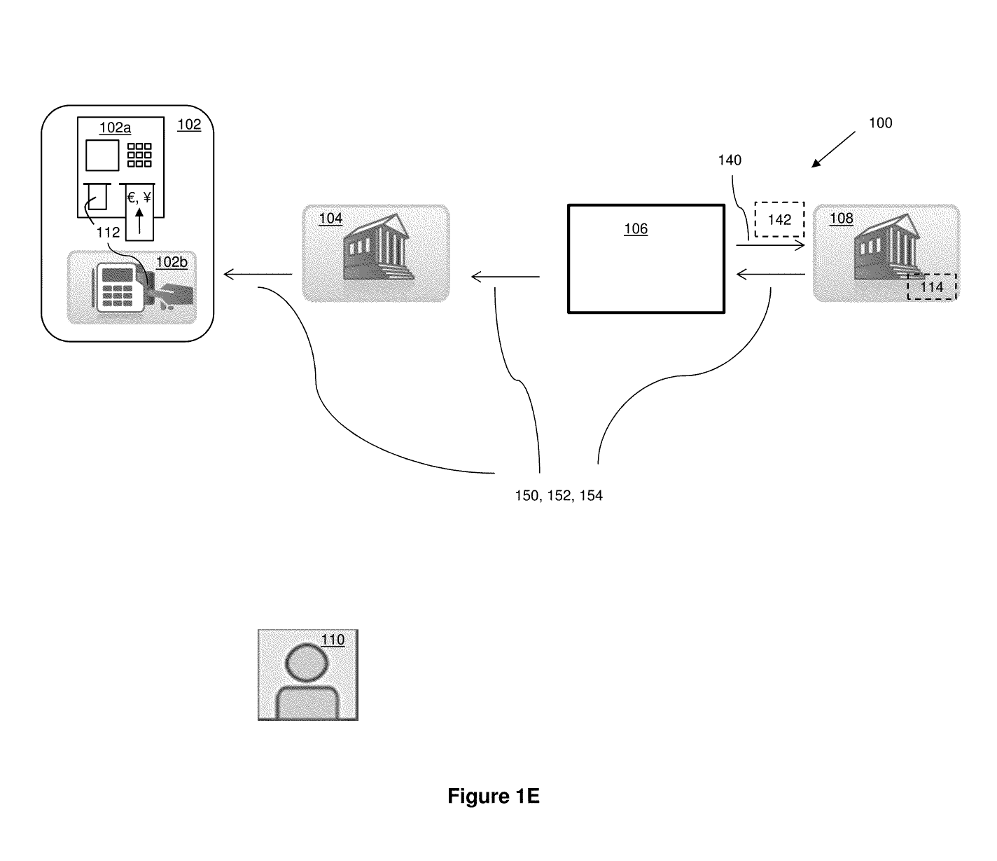

FIGS. 1A to 1E show a schematic of a system 100, the system 100 including a computing terminal 102, an acquirer 104, an intermediary 106 and an issuer 108. Transactions that are supported by the system 100 involve one or more of the entities of the computing terminal 102, the acquirer 104, the intermediary 106 and the issuer 108 during each stage of the transactions. Each of the acquirer 104, the intermediary 106 and the issuer 108 are different parties performing a different function as described below.

A transaction which occurs over the system 100 is typically initiated at the computing terminal 102, so that the computing terminal 102 is any computing device which allows the transaction to tap into the system 100. For example, the computing terminal 102 may be a self-service apparatus, such as a cash deposit machine 102a; or a manned apparatus, such as a point-of-sale (POS) terminal 102b. The cash deposit machine 102a is not necessarily located within store or building premises and may be located outdoors. The POS terminal 102b is typically located in stores of a party that includes any one or more of a merchant, distributor or vendor. The party may be a business offering goods or services.

The acquirer 104 is a participant that seeks authorization from the issuer 108, via the intermediary 106, on whether the transaction performed at the computing terminal 102 meets criteria that allows use of infrastructure provided by the financial services provider to which the intermediary 106 belongs. The acquirer 104 may include any one or more of a bank or a financial institution. In this context, the acquirer 104 can be understood to be the bank of the party where the POS terminal 102b is located or the bank to which the cash deposit machine 102a belongs.

A server network, to which the intermediary 106 belongs, provides an architecture that allows transactions that occur over the system 100. The intermediary 106 acts as a switch between the acquirer 104 and the issuer 108, facilitating the necessary data communication that allows for the transaction initiated at the computing terminal 102 to be completed. In addition, the intermediary 106 also routes funds between the various participants (i.e. the computing terminal 102, the acquirer 104 and the issuer 108) in the system 100.

The issuer 108 provides payment instruments, such as a payment device 112 that may be a payment card can include a credit, a debit card or a prepaid card. The payment device may also include a mobile device (not shown) having stored thereupon payment card data. The mobile device may be a near field communication (NFC) enabled smart phone that is configured to store an electronic version of the above mentioned payment cards as the payment card data. A holder 110 of such a payment device 112 may use the system 100 to credit an account 114 to which the payment device 112 is linked. The issuer 108 may impose one or more criteria that has to be met before the account 114 can be credited. For example, the issuer 108 may provide the holder 110 of such a payment device 112 a threshold limit against which is checked whether the amount to be credited exceeds this threshold limit. If the threshold limit is exceeded, the account 114 will not be credited and the holder 110 is informed accordingly. In this context, the issuer 108 can be understood to be the bank of the holder 110. In the following description, the terms “customer” and “holder” are used interchangeably.

In one implementation, the system 100 provides a means to allow the holder 110 to credit foreign currency, which may for example be leftover from an overseas trip, into the account 114. The system 100 provides this means by supporting a transaction of electronically crediting the account 114 linked to the payment device 112. Each of FIGS. 1A to 1E shows a respective stage of the electronic crediting of the account 114.

In FIG. 1A, the holder 110 has foreign currency 116 which he wants to convert back into home currency, i.e. the currency of the country from which the holder 110 belongs, and credit the converted amount into a bank account of the holder 110. In the implementation shown in FIGS. 1A to 1E, the supported bank account is the account 114 linked to a payment device 112 belonging to the holder 110. With the payment device 112 being issued from the country from which the holder 110 belongs, the payment device 112 uses a home currency, i.e. in a currency different from the foreign currency that is to be credited.

The process of having the foreign currency 116 credited into the account 114 linked to the payment device 112 is initiated by placing 101 the payment device 112, which is linked to the account 114, in communication with the computing terminal 102. It is then determined, in the computing terminal 102, the account 114 to be credited. Details of the account 114 is derived from data stored on the payment device 114 linked to the account. This data is obtained, in the implementation shown in FIG. 1A, by having the computing terminal 102 access the payment device 112 linked to the account 114 in one of two ways.

The first way is when the computing terminal 102 is a cash deposit machine 102a. The holder 110 may insert the payment device 112 into the cash deposit machine 102a, when the payment device 112 is in a physical form (such as a payment card comprising any one or more of a credit card, a debit card or a prepaid card). The account 114 may be obtained by accessing the payment device 112 through the reading of a magnetic strip on the payment device 112 or the reading of an integrated circuit chip on the payment device 112. Should both the cash deposit machine 102a and the payment device 112 be configured to use contactless technology, the payment device 112 need not be inserted into the cash deposit machine 102a, but placed in proximity to a transceiver of the cash deposit machine 102a, whereby the payment device 112 is accessed using a near field communication (NFC) protocol over which the payment device 112 is configured to communicate. On the other hand, if the payment device 112 is a mobile device having stored thereupon payment card data, for example a digital wallet of a NFC enabled smart phone, this would also have the cash deposit machine 102a access such a payment device 112 (in digital form) using a near field communication (NFC) protocol to obtain the account 114.

The second way is when the computing terminal 102 is a POS terminal 102b located, for example, at a merchant store. A cashier at the merchant store may then ask for the payment device 112 from the holder 110. The cashier may insert the payment device 112 into the POS terminal 102b, when the payment device 112 is in a physical form (such as a payment card comprising any one or more of a credit card, a debit card or a prepaid card). The account 114 may be obtained by accessing the payment device 112 through the reading of a magnetic strip on the payment device 112 or the reading of an integrated circuit chip on the payment device 112. Should both the POS terminal 102b and the payment device 112 be configured to use contactless technology, the payment device 112 need not be inserted into the POS terminal 102b, but placed in proximity to a transceiver of the POS terminal 102b, whereby the payment device 112 is accessed using a near field communication (NFC) protocol over which the payment device 112 is configured to communicate. On the other hand, if the payment device 112 is a mobile device having stored thereupon payment card data, for example a digital wallet of a NFC enabled smart phone, this would also have the POS terminal 102b access such a payment device 112 (in digital form) using a near field communication (NFC) protocol to obtain the account 114.

An amount to credit the account 114 is indicated to the computing terminal 102. Since the holder 110 is seeking to credit foreign currency into the account 114, which is in home currency, the amount to credit the account 114 is in a different currency from a currency assigned to the account 114. When the computing terminal 102 is the cash deposit machine 102a, the holder 110 may indicate in a keypad of the cash deposit machine 102a the amount that is to be credited. The holder 110 may also indicate to the cash deposit machine 102a the type of currency (e.g. USD, SGD or AUD) which is being deposited. When the computing terminal 102 is the POS terminal 102b, the cashier at the merchant store may indicate in a keypad of the POS terminal 102b the amount that is to be credited.

The amount in the different currency (i.e. the foreign currency 116) may then be received. When the computing terminal 102 is the cash deposit machine 102a, the holder 110 may be prompted to insert the foreign currency 116, for example, into a money receiving compartment, for the computing terminal 102 to receive the foreign currency 116. The cash deposit machine 102a may be configured to accept a deposit envelope into which the foreign currency 116 is placed for subsequent manual checking, or may be configured to automatically scan the currency directly inserted to ascertain the currency type (e.g. USD, SGD or AUD) and value. The result of this automatic scan would be compared to the type and amount of currency indicated by the holder 110 as having been deposited and an error message provided to the holder 110 if there is a discrepancy between the scan result and the type and amount of currency indicated as having been deposited by the holder 110. If there is a discrepancy, the holder 110 may then choose to terminate the transaction. The manual checking of the type and amount of deposited foreign currency 116 may be performed and rectified, for example, after all deposits in the cash deposit machine 102a are removed in accordance with a collection schedule. A receipt may then be issued by the cash deposit machine 102a on the amount and type of deposited foreign currency 116. There may also be another implementation where the indication to the cash deposit machine 102a of the amount to credit the account is obtained without input from the holder 110, such as where the cash deposit machine 102a is configured to automatically scan the foreign currency 116 to ascertain the currency type and the amount. In such an implementation, a screen of the cash deposit machine 102a may indicate the result of the automatic scan, where the holder 110 is asked to confirm the accuracy of the result of the automatic scan. The holder 110 may choose to terminate the transaction if the automatic scan produces an incorrect result. When the computing terminal 102 is the POS terminal 102b, the cashier at the merchant store may simply receive the foreign currency 116 from the holder 110, check the currency and value thereof and enter the currency and value of the foreign currency 116 into the computing terminal 102, for the account 114 linked to the payment device 112 to be credited. In one implementation, a receipt may then be printed by the POS terminal 102b that shows the amount and the type of foreign currency 116 that is to be credited into the account 114. In another implementation where the currency conversion rate from the type of foreign currency 116 to the currency assigned to the account 114 is already available after the amount and type of the foreign currency 116 is entered into the POS terminal 102b, the printed receipt may indicate either the amount and the type of foreign currency 116 that is to be credited into the account 114; or the amount to be credited in the currency assigned to the account 114; or both.

It is possible for an error to occur at the merchant (such as erroneous counting of the received foreign currency 116 or incorrect entry into the POS terminal 102b) or at the cash deposit machine 102a (such as inaccurate scanning of the inserted foreign currency 116 or erroneous manual checking of the deposit envelope). Thus, it may be an assertion of amount in the different currency that is received, i.e. the received amount in the different currency may differ from the amount that is indicated in the computing terminal 102 to be credited into the account 114,

The order of the steps of receiving the amount in the different currency and the indication of the amount, in the different currency, to credit the account 114 may be reversed, i.e. the amount in the different currency is first received, followed by the indication of the amount to credit the account 114. For instance, the cash deposit machine 102a may first receive the foreign currency 116 from the holder 110 and count the foreign currency 116. The result of the count would then be an indication to the cash deposit machine 102a of the amount to credit the account 114. The cash deposit machine 102a may also ask the holder 110 to confirm the result of the count before indicating the amount that the account 114 is to be credited. In another implementation, the receiving of the amount in the different currency and the indication of the amount to credit the account 114 may be done on or around the same time.

In FIG. 1B, the computing terminal 102 sends 130 an indication 120 of the amount that is to be credited to the account 114 to the acquirer 104. The computing terminal 102 may also send to the acquirer 104 transaction details 118, which include the currency of the amount, the payment device 112 details and the currency assigned to the payment device 112. There may also be other data in the transaction details 118 which is relevant to the transaction, such as the location of the computing terminal 102 and the time of transaction.

Following the receipt of the indication 120 of the amount that is to be credited to the account 114 and the transaction details 118, the acquirer 104 may follow one of the two processes described with reference to FIGS. 10 and 1D. The first process of FIG. 10 has the intermediary 106 perform the currency conversion of the foreign currency 116 (see FIG. 1A) into the currency assigned to the account 114. The second process of FIG. 1D has the acquirer 104 perform the currency conversion of the foreign currency 116 (see FIG. 1A) into the currency assigned to the account 114. The currency conversion service provided by each of the acquirer 104 and the intermediary 106 may be accessed via a respective server that acts as a gateway to the acquirer 104 and the intermediary 106.

In the first process shown in FIG. 10, the acquirer 104 provides 132 the intermediary 106 with the indication 120 of the amount that is to be credited to the account 114 and the transaction details 118. These transaction details 118 allow the intermediary 106 to identify the issuer 108 that is administering the account 114.

Conversion of the amount into the currency assigned to the account 114 is performed (depicted using the reference numeral 138) before the account 114 is credited. In one implementation, the intermediary 106 may obtain currency rates at which currency conversion occurs from external financial services providers (not shown). The intermediary 106 may then determine a currency rate, from these obtained currency rates, at which the intermediary 106 performs the currency conversion 138.

In the second process shown in FIG. 1D, conversion of the amount into the currency assigned to the account 114 is performed (depicted using the reference numeral 138) at the acquirer 104. The acquirer 104 may determine a currency rate from external financial services providers (not shown), to which the acquirer 104 uses to perform the currency conversion 138. The acquirer 104 performs the currency conversion at the determined currency rate and provides 132 the intermediary 106 with an indication 122 of the converted amount (i.e. in the currency assigned to the account 114) that is to be credited to the account 114. In addition, the acquirer 104 also provides 132 the transaction details 118 to the intermediary 106, where these transaction details 118 also allow the intermediary 106 to identify the issuer 108 that is administering the account 114.

In FIG. 1E, the issuer 108 that issued the payment device 112 is identified by the intermediary 106, so that the issuer 108 may designate the correct account 114 that is to be credited. After the issuer 108 is identified, the issuer 108 may seek confirmation 150, via the computing terminal 102, from the holder 110 whether the account 114 linked to the payment device 112 is to be credited. This confirmation 150 may provide an indication of the amount, in the currency assigned to the account 114 (i.e. the home currency), that the account 114 would be credited. This confirmation 150 reaches the terminal 102 by first being transmitted from the issuer 108 to the intermediary 106, then from the intermediary 106 to the acquirer 104 and finally from the acquirer 104 to the terminal 102. After approval is obtained from the issuer 108, the account 114 linked to the payment device 112 is credited 140 with the amount 142 in the currency assigned to the account 114, the amount 142 being derived from the foreign currency 116, see FIG. 1A. As a further optional step, authorization from the issuer 108 of the payment device 112 may be requested before crediting the account 114. As part of this authorization, it is determined whether the amount 142 to be credited into the account 114 is within a threshold limit. If the threshold limit is exceeded, the holder 110 is informed 152 through the computing terminal 102, with the computing terminal 102 obtaining a message that this threshold limit is exceeded via the same path used by the confirmation 150. After the account 114 is successfully credited with the amount 142, an approval 154 message will be sent to the computing terminal 102. The approval 154 message reaches the computing terminal 102 via the same path used by the confirmation 150. In a preferred embodiment, a single data packet may be used to provide the messages 150, 152 and 154.

There are further steps that occur to complete the transaction of electronically crediting the account 114, as initiated by providing the foreign currency 116 to the computing terminal 102 (see FIG. 1A). These further steps are described below, using the example where the transaction is initiated by way of providing foreign currency 116 to the POS terminal 102b.

After the issuer 108 authorizes the crediting of the account 114, as described with reference to FIG. 1E, the amount to be credited into the account 114 is placed on hold, pending clearing of the transaction. The merchant where the POS terminal 102b is located may maintain a ledger with the acquirer 104. The ledger captures all transactions processed through the POS terminal 102b. The ledger is updated for any financial activity that involves the use of the system 100 of FIGS. 1A to 1E. Such financial activity may include the electronic crediting of the account 114, as described with respect to FIGS. 1A to 1E, or a purchase made on the payment device 112 for a good or service provided by the merchant. The electronic crediting of the account 114 would lead to a decrease in balance in the merchant's ledger where a decrease would means funds being transferred from the merchant to the acquirer 104. A purchase made on the payment device 112 for a good/service provided by the merchant would lead to an increase in balance in the ledger, where an increase would mean funds transferred from the acquirer 104 to merchant

A similar ledger is maintained between the acquirer 104 and the intermediary 106; and between the intermediary 106 and the issuer 108. The intermediary 106 facilitates the transfer of funds between the acquirer 104 and the issuer 108. The clearing of the ledger maintained between the acquirer 104 and the issuer 108 serves to release the amount that is placed on hold, which leads to the account 114 being credited with the value of the foreign currency 116 in the currency assigned to the account 114.

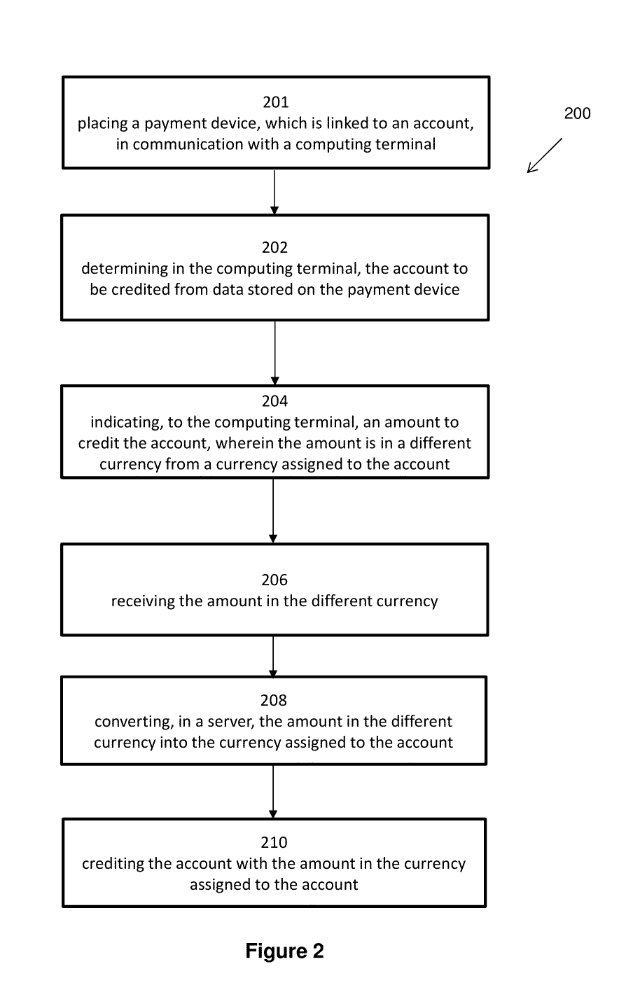

From FIGS. 1A to 1E, it will be appreciated that the system 100 supports a method 200 having the steps 201, 202, 204, 206, 208 and 210 as illustrated in FIG. 2. The method 200, that the system 100 supports, allows the remote electronic crediting of an account linked to a payment device (confer the account 114 maintained by the issuer 108). The crediting of the account is remote in the sense that the crediting of the account linked to the payment device is initiated in an indirect manner, i.e. it is initiated before a proxy to the issuer of the payment device (i.e. the issuer 108) and not directly before a bank of the issuer of the payment device. With reference to FIGS. 1A to 1E, this remote electronic crediting of the account 114 is facilitated by the intermediary 106 that routes funds and data to the other participants (i.e. the computing terminal 102, the acquirer 104 and the issuer 108) in the system 100 that are involved in the crediting of the account 114.

Step 201 involves placing the payment device, which is linked to the account, in communication with a computing terminal.

Step 202 involves determining, in the computing terminal, the account to be credited from data stored on the payment device linked to the account.

Step 204 involves indicating, to the computing terminal, an amount to credit the account, wherein the amount is in a different currency from a currency assigned to the account.

Step 206 involves receiving the amount in the different currency.

Step 208 involves converting, in a server, the amount in the different currency into the currency assigned to the account.

Step 210 involves crediting the account with the amount in the currency assigned to the account.

The steps 202 to 210 do not necessarily follow the sequence shown in FIG. 2, i.e. of step 201 being performed first, followed by steps 202, 204, 206, 208 and 210. For instance, as mentioned above, steps 204 and 206 may be interchanged, i.e. step 206 occurs before step 204.

With reference to FIGS. 1A to 1E, the method 200 provides the holder 110 of the payment device 112 a means to conveniently credit foreign currency back into the account 114 linked to the payment device 112. With the crediting being performed by a computing terminal, such as a cash deposit machine 102a or a POS terminal 102b, a variety of locations or touch points are provided to the holder 110 to avail themselves to this crediting service. This crediting service also increases the capabilities of the payment device 112, in addition to being usable for traditional purchase of goods and/or services. It is also to be appreciated that the account 114 to which the payment device 112 is linked is credited with the converted foreign currency, rather than directly crediting the payment device 112 through a stored value mechanism. Thus, even if the payment device 112 is lost, the credited amount, being lodged into the account 114 is secured. In the case where the holder 110 has several payment devices 112 that are issued from the same issuer 108, it may be possible to implement a pooling system, whereby the respectively linked accounts 114 can tap the funds from the account 114 selected to be credited with the converted foreign currency, with the funds being derived from the crediting of this selected account 114. One way to implement this pooling system is for the issuer 108 to maintain a repository which is drawn down from all accounts 114 that belong to the holder 110. The amount in this repository is increased each time any one of the accounts 114 is credited.

Use of the term ‘server’ herein may be understood to mean a single computing device or a plurality of interconnected computing devices which operate together to perform a particular function. That is, the server may be contained within a single hardware unit or be distributed among several or many different hardware units.

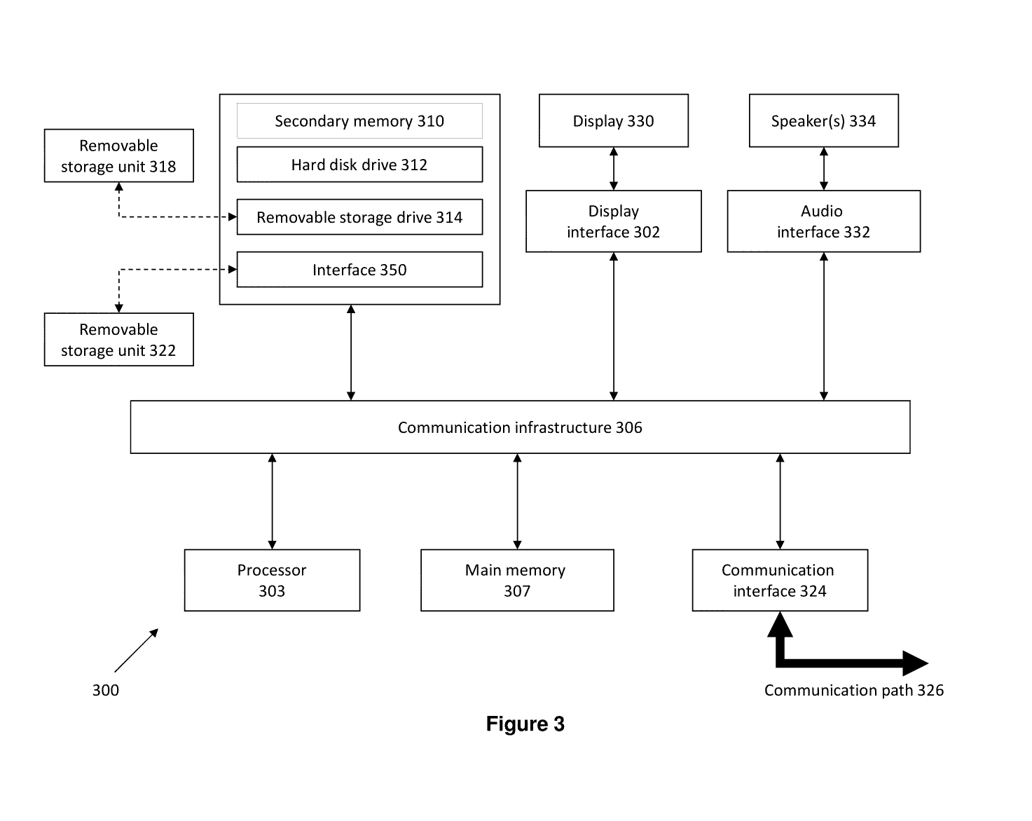

FIG. 3 shows an exemplary computing device 300, to realize a server for the intermediary 106 shown in FIGS. 1A to 1E. The following description of the computing device 300 is provided by way of example only and is not intended to be limiting. Therefore, one or more elements/components of the computing device 300 may be omitted. Also, one or more elements/components of the computing device 300 may be combined together. Additionally, one or more elements/components of the computing device 300 may be split into one or more component parts.

With reference to FIG. 3, the exemplary computing device 300 includes a processor 303 for executing software routines. Although a single processor is shown for the sake of clarity, the computing device 300 may also include a multi-processor system. The processor 303 is connected to a communication infrastructure 306 for communication with other components of the computing device 300. The communication infrastructure 306 may include, for example, a communications bus, cross-bar, or network.

The computing device 300 further includes a main memory 307, such as a random access memory (RAM), and a secondary memory 310. The secondary memory 310 may include, for example, a hard disk drive 312 and/or a removable storage drive 314, which may include a floppy disk drive, a magnetic tape drive, an optical disk drive, or the like. The removable storage drive 314 reads from and/or writes to a removable storage unit 318 in a well-known manner. The removable storage unit 318 may include a floppy disk, magnetic tape, optical disk, or the like, which is read by and written to by removable storage drive 314. As will be appreciated by persons skilled in the relevant art(s), the removable storage unit 318 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface (such as that found in video game console devices), a removable memory chip (such as an EPROM or PROM) and associated socket, and other removable storage units 322 and interfaces 350 which allow software and data to be transferred from the removable storage unit 322 to the computing device 300.

The computing device 300 also includes at least one communication interface 324. The communication interface 324 allows software and data to be transferred between computing device 300 and external devices via a communication path 326. In various implementations, the communication interface 324 permits data to be transferred between the computing device 300 and a data communication network, such as a public data or private data communication network. The communication interface 324 may be used to exchange data between different computing devices 300 which such computing devices 300 form part an interconnected computer network. Examples of a communication interface 324 can include a modem, a network interface (such as an Ethernet card), a communication port, an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 334.

As used herein, the term “computer program product” may refer, in part, to removable storage unit 318, removable storage unit 322, a hard disk installed in hard disk drive 312, or a carrier wave carrying software over communication path 326 (wireless link or cable) to communication interface 324. A computer readable medium can include magnetic media, optical media, or other recordable media, or media that transmits a carrier wave or other signal. These computer program products are devices for providing software to the computing device 300. Computer readable storage medium refers to any non-transitory tangible storage medium that provides recorded instructions and/or data to the computing device 300 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 307 and/or secondary memory 310. Computer programs can also be received via the communication interface 324. Such computer programs, when executed, enable the computing device 300 to perform one or more steps that facilitate the electronic crediting of the account 114 linked to the payment device 112, as described above with reference to FIGS. 1A-1E. The computer programs, when executed, enable the processor 303 to, for example, identify that the account 114 is to be credited and ensure that the account 114 is credited with a home currency, rather than a foreign currency. Accordingly, such computer programs may represent controllers of the computing device 300.

Software may be stored in a computer program product and loaded into the computing device 300 using the removable storage drive 314, the hard disk drive 312, or the interface 350. Alternatively, the computer program product may be downloaded to the computing device 300 over the communications path 326.

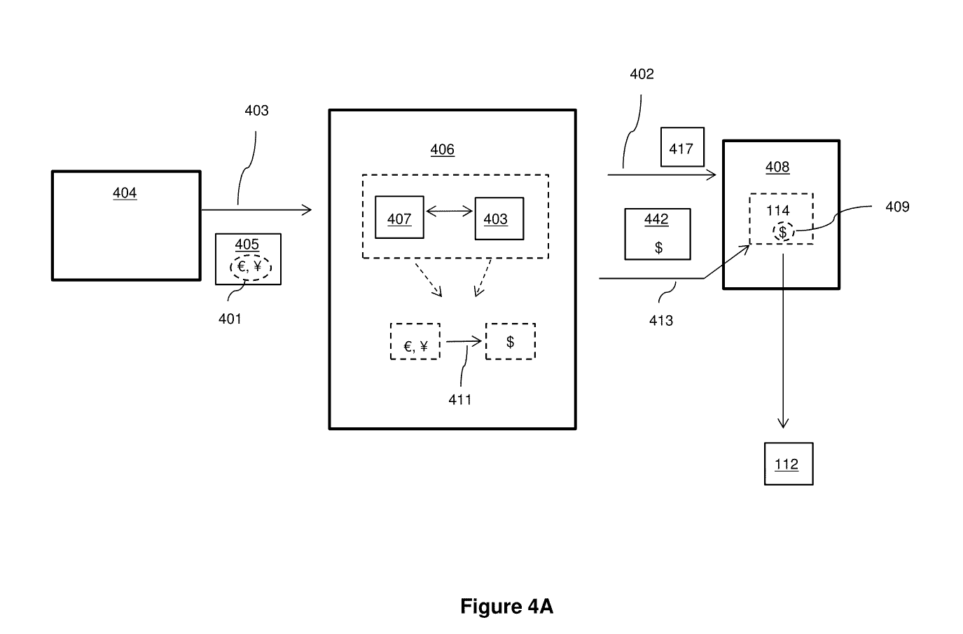

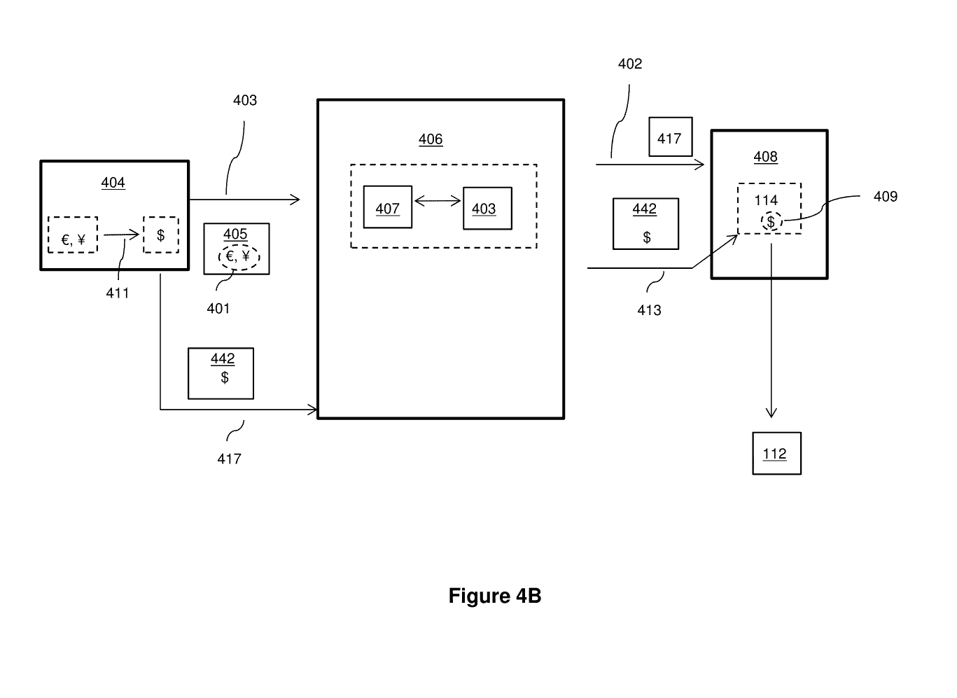

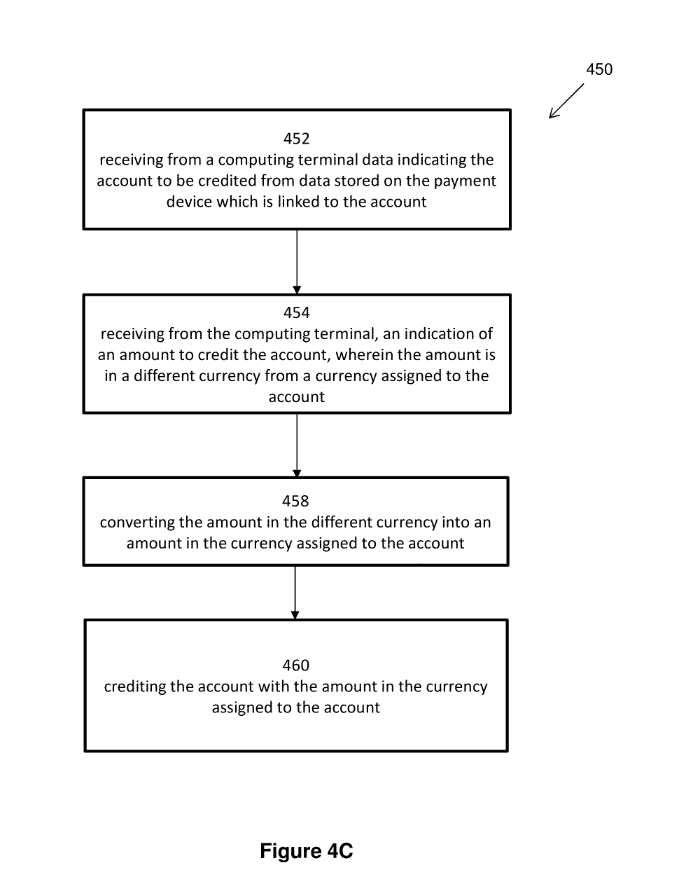

FIGS. 4A and 4B each show a schematic of a server 406 for the intermediary 106 shown in the system 100 of FIGS. 1A-1E. The server 406 is shown to be in communication with a server 408 of the issuer 108 shown in the system 100 of FIGS. 1A-1E. The server 406 includes at least one processor 403 and at least one memory 407. Other components that the server 406 may have are omitted for the purposes of simplicity.

The server 406 of the intermediary 106 facilitates a transaction between a server 404 of the acquirer 104 and the server 408 of the issuer 108 of the payment device 112. In the implementation described in FIGS. 1A to 1E, the transaction credits the account 114 linked to the payment device 112 when remote electronic crediting of the account 114 is initiated. The electronic crediting of the account 114 is initiated at the computing terminal 102 which is in communication with the acquirer 104 and the crediting of the account is performed by the server 408.

Computer program code within the at least one memory 407 is configured to have the at least one memory 407, with the at least one processor 403, cause the server 406 at least to determine 402 the account 114 to be credited from data stored on the payment device 112 which is linked to the account 114. The server 406 may communicate with the server 408 when performing this determination. The server 406 is further configured to receive 403 (for example, from the server 404) data indicative of an amount 405 to credit the account 114, wherein the amount 405 is in a different currency 401 from a currency 409 assigned to the account 114. The server 406 is further configured to obtain an indication of the amount converted 411 in the currency 409 assigned to the account 114. The server 406 is configured to provide 413 the account 114 with the indication of the amount 442 converted in the currency 409 assigned to the account 114 to be credited into the account 114. The server 406 sends a message providing an indication of the amount 442 to the server 408, where the server 408 will designate the account 114 to credit the account 114 with the amount 442 that is in the currency 409 assigned to the account 114.

In the implementation shown in FIG. 4A, the at least one memory 407 and the computer program code are further configured to, with the at least one processor 403, cause the server 406 to perform conversion of the amount 405 in the different currency 401 to obtain the indication of the amount 442 converted in the currency 409 assigned to the account 114. In such an implementation, the server 406 performs the currency conversion 411. The server 406 may determine an exchange rate from one or more rates obtained from external financial services providers (not shown) and perform the currency conversion 411 at that determined exchange rate.

In another implementation, the indication of the amount 442 converted in the currency 409 assigned to the account 114 is obtained from an external conversion of the amount 405 in the different currency 401. This other implementation is shown in FIG. 4B.

In the implementation of FIG. 4B, the server 404 performs the currency conversion 411. The server 406 still receives 403 an assertion of the amount 405 to credit the account 114, wherein the amount 405 is in a different currency 401 from the currency 409 assigned to the account 114. The receipt 403 of this assertion of the amount 405 in the different currency 401 provides an indication to the server 406 that the amount 442 to credit the account 114 originated from the amount 405 in the different currency 401. The server 406 then obtains 417, from the server 404, the indication of the amount 442 converted in the currency 409 assigned to the account 114.

The at least one memory 407 and the computer program code are further configured to, with the at least one processor 403, cause the server 406 to request authorization from the issuer of the payment device 112 to credit the account 114. This may be done by the server 406 sending an authorization request message 417 to the server 408, which is sent together with the designation 402 of the account 114. The authorization request message 417 may further determine whether the amount 442 to be credited into the account 114 is within a threshold limit.

The server 406 is thus able to electronically credit an account linked to a payment device in accordance with a method 450 shown in FIG. 4C.

In step 452, the server 406 receives from a computing terminal data indicating the account to be credited from data stored on the payment device which is linked to the account.

In step 454, an indication of an amount to credit the account, wherein the amount is in a different currency from a currency assigned to the account, is received in the server 406 from the computing terminal,

In step 458, the amount in the different currency is converted into an amount in the currency assigned to the account. This conversion may be performed by the server 406 or by the server 404.

In step 460, the server 406 credits the account with the amount in the currency assigned to the account

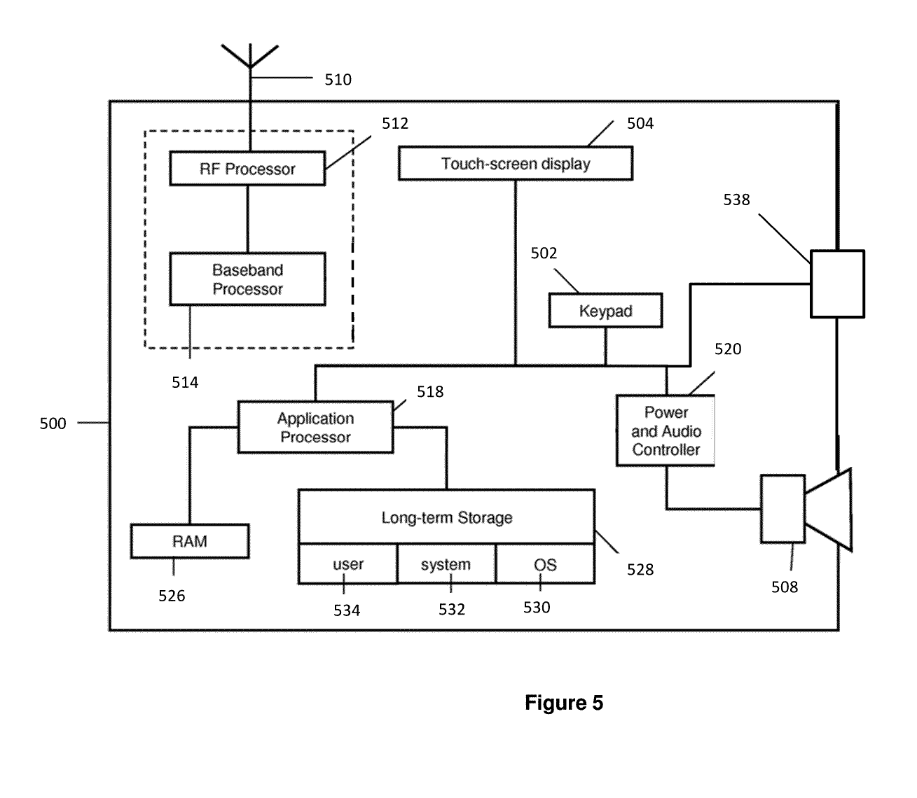

FIG. 5 is a schematic of an exemplary computing device 500 that may be utilized to implement the computing terminal 102 shown in FIGS. 1A to 1E. The device 500 may be in communication (e.g. via an Internet connection) with another wireless device (e.g. a payment device which is NFC enabled or a NFC enabled smart phone).

The device 500 comprises a keypad 502, a touch-screen 504, a speaker 508 and an antenna 510.

The device 500 comprises hardware to perform communication functions (e.g. data communication), together with an application processor 518 and corresponding support hardware. The communication hardware is represented by the RF processor 512 which provides an RF signal to the antenna 510 for the transmission of data signals, and the receipt therefrom. Additionally provided is a baseband processor 514, which provides signals to and receives signals from the RF Processor 512. The communication subsystem enables the device 500 to communicate via a number of different communication protocols including WiFi, Wi-Fi direct, Near Field Communication (NFC) and/or Bluetooth™.

The keypad 502 and the touch-screen 504 are controlled by an application processor 518, which allows the device 500 to receive input that facilitates electronic crediting of the account linked to the payment device, such as the amount of the foreign currency that is to be credited into the account. A power and audio controller 520 is provided to supply power to the communication subsystem, the application processor 518, and the other hardware. The power and audio controller 520 also controls audio output via the speaker 508.

In order for the application processor 518 to operate, various different types of memory are provided. Firstly, the wireless device 500 includes Random Access Memory (RAM) 526 connected to the application processor 518 into which data and program code can be written and read from at will. Code placed anywhere in RAM 526 can be executed by the application processor 518 from the RAM 526. RAM 526 represents a volatile memory of the wireless device 500.

Secondly, the device 500 is provided with a long-term storage 528 connected to the application processor 518. The long-term storage 528 comprises three partitions, an operating system (OS) partition 530, a system partition 532 and a user partition 534. The long-term storage 528 represents a non-volatile memory of the device 500.

In the present example, the OS partition 530 contains the firmware of the device 500 which includes an operating system. Other computer programs may also be stored on the long-term storage 528, such as application programs, and the like. In particular, application programs which are mandatory to the device 500, such as, communications applications that allow the device 500 to communicate with the acquirer 104 and the like are typically stored in the system partition 532. The application programs stored on the system partition 532 would typically be those which are bundled with the device 500 by the device manufacturer when the device 500 is first sold.

Application programs which are added to the device 500 by the user would usually be stored in the user partition 534.

As stated, the representation of FIG. 5 is schematic. In practice, the various functional components illustrated may be substituted into one and the same component. For example, the long-term storage 528 may comprise NAND flash, NOR flash, a hard disk drive or a combination of these.

The device 500 may also have an image capturing module (not shown). The image capturing module, together with a suitable application, may be used to capture/scan QR codes and process the data embedded in the QR code.

In implementing the computing device 500 as the computing terminal (see reference numeral 102 of FIGS. 1A to 1E), the computing terminal is able to remotely electronically credit an account linked to a payment device through an intermediary that is in communication with the issuer of the payment device. The computing terminal comprises at least one processor (e.g. application processor 518); and at least one memory (e.g. RAM 526, long-term storage 528) including computer program code; the at least one memory and the computer program code configured to, with the at least one processor, cause the computing terminal at least to: detect that the payment device, which is linked to the account, is placed in communication with the computing terminal. The computing terminal is also configured to determine the account to be credited from data stored on the payment device. The computing terminal is further configured to receive an indication of an amount to credit the account, wherein the amount is in a different currency from a currency assigned to the account. The computing terminal is further configured to transmit data indicative of the received amount for conversion into the currency assigned to the account and subsequent crediting into the account. The conversion may be done by an acquirer (compare acquirer 104 described with reference to FIG. 1D) or performed by an intermediary (compare intermediary 106 described with reference to FIG. 1C).

The computing terminal may further comprise a scanner 538 that is configured to access the payment device linked to the account, wherein the at least one memory and the computer program code are further configured to, with the at least one processor, cause the computing terminal to obtain the account to be credited from the scanner accessing the payment device. The scanner 538 may comprise any one or more of the following: a magnetic strip reader, an integrated circuit chip reader and a near field communication protocol enabled transceiver. Alternatively, the near field communication protocol (NFC) enabled transceiver may be realised by the combination of the antenna 510, the baseband processor 514 and the RF Processor 512. A NFC protocol may be used when the payment device exists in electronic form, such as a mobile device having stored thereupon payment card data, for example stored in a digital wallet of a NFC enabled device. In such an implementation, the computing terminal will, in addition to being in communication with the acquirer 104, also be in communication with the NFC enabled payment device. As mentioned above, the computing terminal may be any one or more of a cash deposit machine or a point-of-sale terminal. In the case where the computing terminal is a cash deposit machine, the cash deposit machine comprises a compartment (not shown) configured to receive the amount in the different currency as a deposit in the cash deposit machine. The cash deposit machine may further comprise a scanner (not shown) that is configured to detect the type of foreign currency (e.g. USD, SGD or AUD) that is deposited.

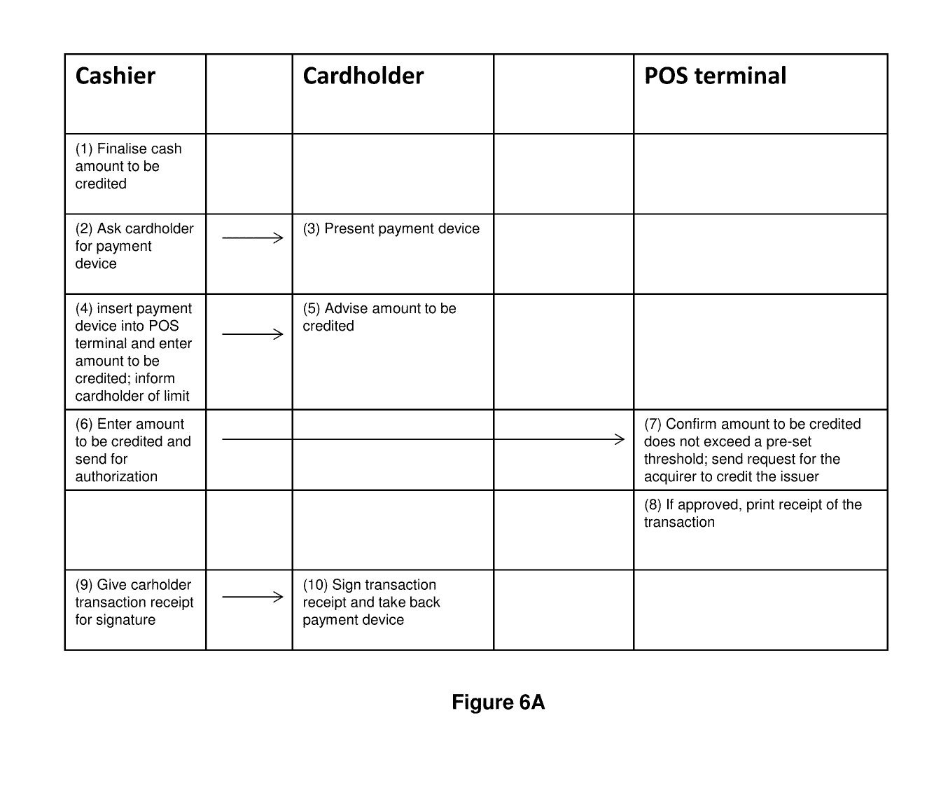

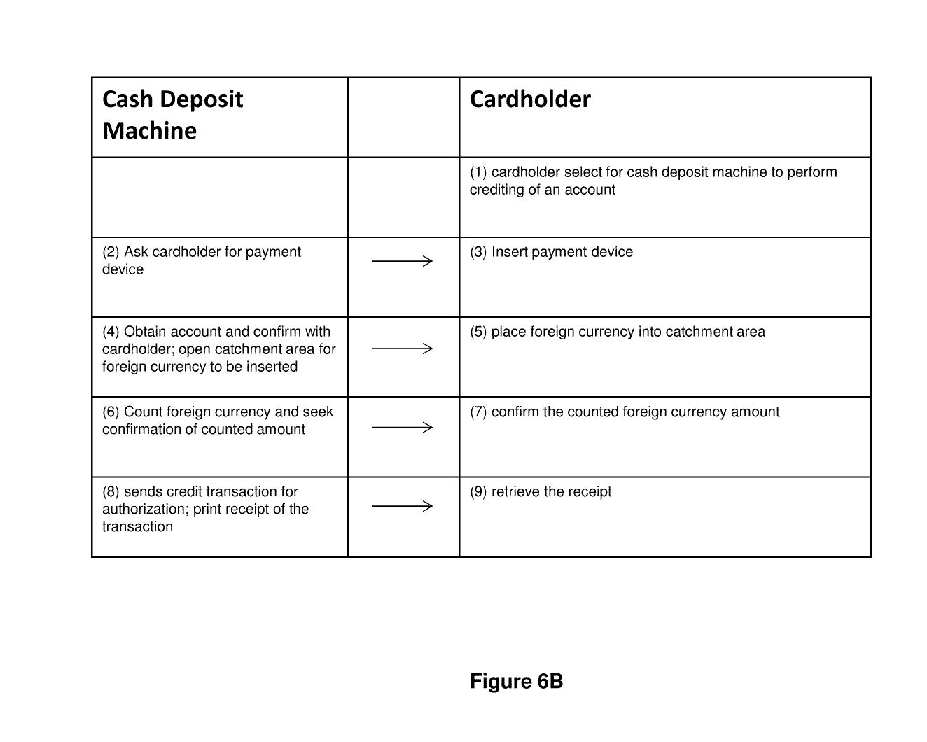

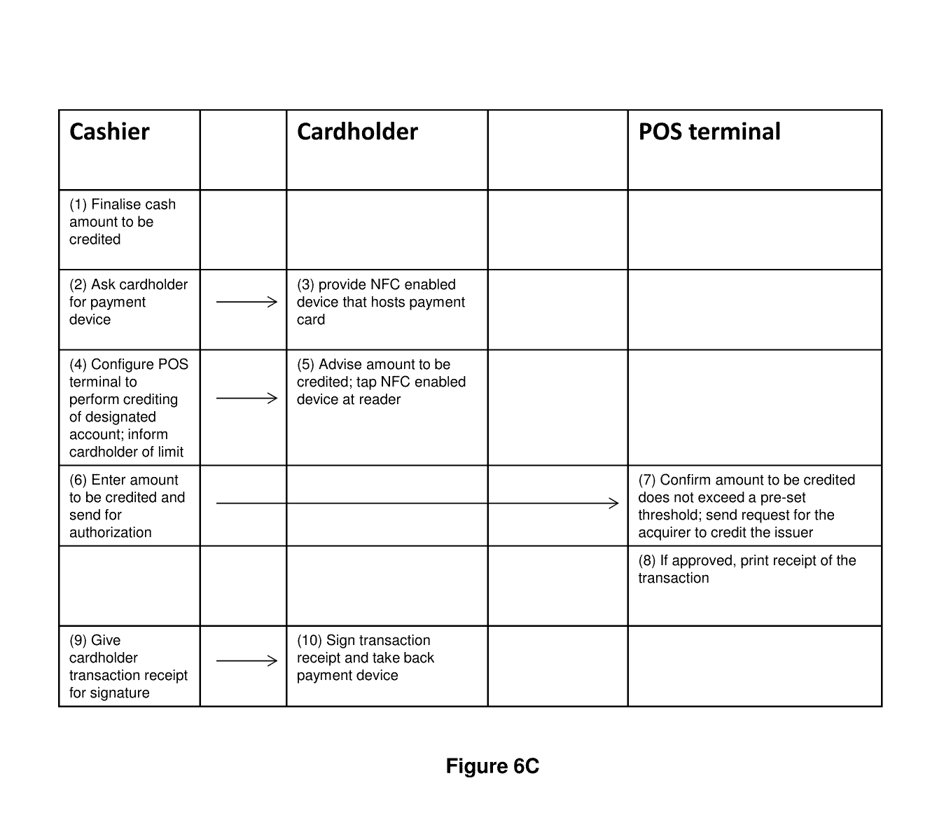

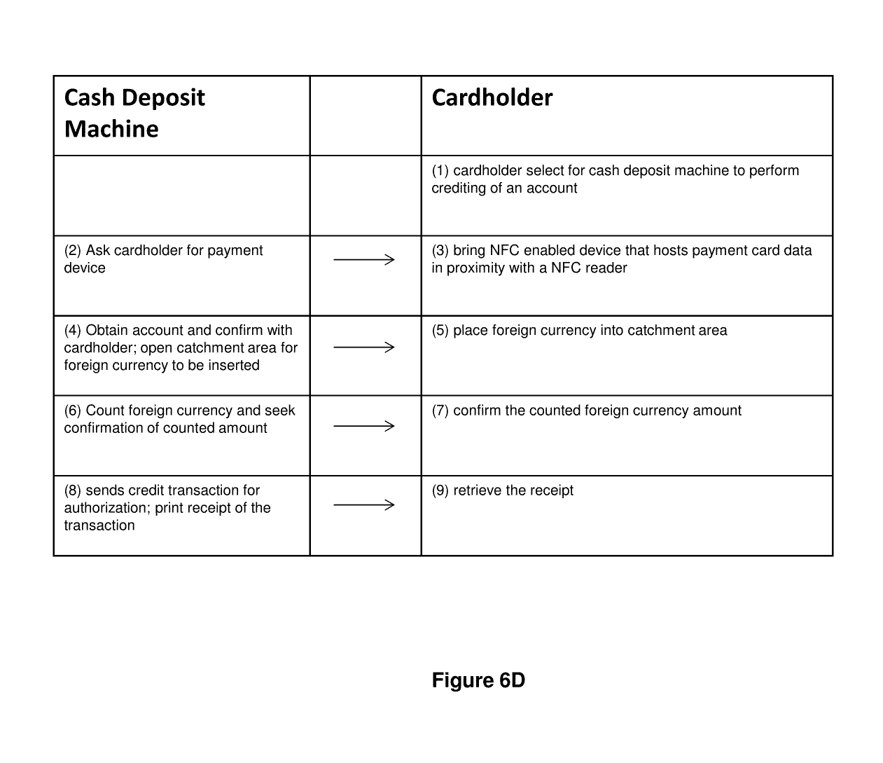

The payment device described with reference to FIGS. 1 to 5 may also be a payment card comprising any one or more of a credit card, a debit card, or prepaid card. FIGS. 6A to 6D each illustrate a sequence that may be followed when the computing terminal is a POS terminal or a cash deposit machine and the account to be credited is linked to a payment device that exists in either physical or digital form.

FIG. 6A refers to a scenario where crediting of the account linked to a payment device is processed by a POS terminal, wherein the payment device exists in physical form.

The sequence begins (1) with the cashier finalising the cash amount to be credited. This cash amount is in foreign currency. The cashier asks (2) the cardholder for a payment device. The cardholder provides (3) the payment device linked to the account that is to be credited. The cashier inserts (4) the payment device into the POS terminal and enters the amount to be credited. If there is a limit imposed and the amount to be credited exceeds the imposed limit, the cardholder is informed. At (5), the cardholder advises the amount in the foreign currency to be credited into the account linked to the payment device. The cashier enters (6) the amount to be credited into the POS terminal and sends the credit transaction for authorization. At (7), the POS terminal confirms that the amount to be credited does not exceed a pre-set threshold. If the pre-set threshold is not exceeded, a request for the acquirer to credit the issuer with the indicated amount is sent to the acquirer for processing. If the issuer approves (8) the credit transaction, the POS terminal prints a receipt of the transaction. The cashier gives (9) the cardholder the receipt for his signature and verification. At (10), the cardholder signs the transaction receipt and takes back the payment device.

FIG. 6B refers to a scenario where crediting of the account linked to a payment device is processed by a cash deposit machine, wherein the payment device exists in physical form.

The sequence begins (1) with the cardholder selecting for the cash deposit machine to perform crediting of an account linked to a payment device. The cash deposit machine asks (2) for a payment device to be inserted. The cardholder inserts (3) the payment device. At (4), the account is obtained from the payment device and confirmed with the cardholder. After the account is confirmed, a catchment area opens for foreign currency to be inserted. The cardholder places (5) foreign currency into the catchment area. The cash deposit machine then counts (6) the foreign currency and seeks confirmation of the counted amount. At (7), the cardholder confirms the counted foreign currency amount. The cash deposit machine sends (8) the credit transaction for authorization. Upon approval of the credit transaction, the cash deposit machine prints a receipt of the transaction. At (9), the cardholder retrieves the receipt.

FIG. 6C refers to a scenario where crediting of the account linked to a payment device is processed by a POS terminal, wherein the payment device exists in digital form.

The sequence begins (1) with the cashier finalising the cash amount to be credited. This cash amount is in foreign currency. The cashier asks (2) the cardholder for a payment device. The cardholder provides (3) an NFC enabled device that hosts the payment device in a digital wallet. The cashier configures (4) the POS terminal to perform crediting of a designated account. The cashier informs the cardholder of credit limits, if any, and requests for the NFC enabled device to be placed in proximity to a NFC reader of the POS terminal. At (5), the cardholder advises the amount in the foreign currency to be credited into the account linked to the payment device and brings the NFC enabled device into proximity with the POS terminal for the POS terminal to obtain the account to be credited. The cashier enters (6) the amount to be credited into the POS terminal and sends the credit transaction for authorization. At (7), the POS terminal confirms that the amount to be credited does not exceed a pre-set threshold. If the pre-set threshold is not exceeded, a request for the acquirer to credit the issuer with the indicated amount is sent to the acquirer for processing. If the issuer approves (8) the credit transaction, the POS terminal prints a receipt of the transaction. The cashier gives (9) the cardholder the receipt for his signature and verification. At (10), the cardholder signs the transaction receipt and takes back the payment device.

FIG. 6D refers to a scenario where crediting of the account linked to a payment device is processed by a cash deposit machine, wherein the payment device exists in digital form.

The sequence begins (1) with the cardholder selecting for the cash deposit machine to perform crediting of an account linked to a payment device. The cash deposit machine asks (2) for a payment device to be inserted. At (3), the cardholder brings a NFC enabled device that hosts the payment device in a digital wallet in proximity with a NFC reader at the cash deposit machine. At (4), the account is obtained from the payment device and confirmed with the cardholder. After the account is confirmed, a catchment area opens for foreign currency to be inserted. The cardholder places (5) foreign currency into the catchment area. The cash deposit machine then counts (6) the foreign currency and seeks confirmation of the counted amount. At (7), the cardholder confirms the counted foreign currency amount. The cash deposit machine sends (7) the credit transaction for authorization. Upon approval of the credit transaction, the cash deposit machine prints a receipt of the transaction. At (9), the cardholder retrieves the receipt.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of remotely electronically crediting an account linked to a payment device, the method comprising:
placing the payment device, which is linked to the account, in communication with a computing terminal;
determining in the computing terminal, the account to be credited from data stored on the payment device;
indicating, to the computing terminal, an amount to credit the account, wherein the amount is in a different currency from a currency assigned to the account;
receiving the amount in the different currency;
converting, in a server, the amount in the different currency into the currency assigned to the account; and
crediting the account with the amount in the currency assigned to the account.

2. The method in accordance with claim 1, wherein the payment device is a payment card comprising any one or more of a credit card, a debit card or a prepaid card.

3. The method in accordance with claim 1, wherein the payment device is a mobile device having stored thereupon payment card data.

4. The method in accordance with claim 1, wherein the step of determining the account to be credited further comprises having the computing terminal access the payment device linked to the account.

5. The method in accordance with claim 4, wherein the payment device is accessed using any one or more of the following techniques of reading a magnetic strip on the payment device, reading an integrated circuit chip on the payment device and using a near field communication protocol over which the payment device is configured to communicate.

6. The method in accordance with claim 1, wherein the computing terminal comprises any one or more of a cash deposit machine or a point-of-sale terminal.

7. The method of claim 6, wherein the cash deposit machine operates to receive the amount in the different currency, ascertains the currency and value thereof and provides the currency and value thereof.

8. The method of claim 6, wherein an operator of the point-of-sale terminal receives the amount in the different currency, checks the currency and value thereof and enters the currency and value thereof into the computing terminal for crediting the account linked to the payment device.

9. The method in accordance with claim 1, wherein the step of crediting the account comprises: requesting authorization from an issuer of the payment card before crediting the account.

10. The method in accordance with claim 1, wherein the crediting of the account and the receiving of the amount in the different currency is each performed by a different party.

11. A server for an intermediary that facilitates crediting of an account linked to a payment device when remote electronic crediting of the account is initiated, the server comprising:
at least one processor; and
at least one memory including computer program code;
the at least one memory and the computer program code configured to, with the at least one processor, cause the server at least to:
determine the account to be credited from data stored on the payment device which is linked to the account;
receive data indicative of an amount to credit the account, wherein the amount is in a different currency from a currency assigned to the account;
obtain an indication of the amount converted in the currency assigned to the account; and
provide the account with the indication of the amount converted in the currency assigned to the account to be credited into the account.

12. The server in accordance with claim 11, wherein the at least one memory and the computer program code are further configured to, with the at least one processor, cause the server to: perform conversion of the amount in the different currency to obtain the indication of the amount converted in the currency assigned to the account.

13. The server in accordance with claim 11, wherein the indication of the amount converted in the currency assigned to the account is obtained from an external conversion of the amount in the different currency.

14. The server in accordance with claim 11, wherein the payment device is a payment card comprising any one or more of a credit card, a debit card or a prepaid card.

15. The server in accordance with claim 11, wherein the payment device is a mobile device having stored thereupon payment card data.

16. The server in accordance with claim 11, wherein the at least one memory and the computer program code are further configured to, with the at least one processor, cause the server to: request authorization from the issuer of the payment device to credit the account.

17. The server in accordance with claim 16, wherein the request for authorization further comprises: determining whether the amount to be credited into the account is within a threshold limit.

18. A method of electronically crediting an account linked to a payment device, the method comprising:
receiving from a computing terminal data indicating the account to be credited from data stored on the payment device which is linked to the account;
receiving from the computing terminal, an indication of an amount to credit the account, wherein the amount is in a different currency from a currency assigned to the account;
converting the amount in the different currency into an amount in the currency assigned to the account; and
crediting the account with the amount in the currency assigned to the account.

19. A computing terminal for remotely electronically crediting an account linked to a payment device, the computing terminal comprising:
at least one processor; and
at least one memory including computer program code;
the at least one memory and the computer program code configured to, with the at least one processor, cause the computing terminal at least to:
detect that the payment device, which is linked to the account, is placed in communication with the computing terminal;
determine the account to be credited from data stored on the payment device; and
receive an indication of an amount to credit the account, wherein the amount is in a different currency from a currency assigned to the account; and
transmit data indicative of the received amount for conversion into the currency assigned to the account and subsequent crediting into the account.

20. The computing terminal in accordance with claim 19, wherein the payment device is a payment card comprising any one or more of a credit card, a debit card or a prepaid card.

21. The computing terminal in accordance with claim 19, wherein the payment device is a mobile device having stored thereupon payment card data.

22. The computing terminal in accordance with claim 19, further comprising a scanner configured to access the payment device linked to the account, wherein the at least one memory and the computer program code are further configured to, with the at least one processor, cause the computing terminal to obtain the account to be credited from the scanner accessing the payment card.

23. The computing terminal in accordance with claim 22, wherein the scanner comprises any one or more of the following: a magnetic strip reader, an integrated circuit chip reader and a near field communication protocol enabled transceiver.

24. The computing terminal in accordance with claim 19, wherein the computing terminal comprises any one or more of a cash deposit machine or a point-of-sale terminal.

25. The computing terminal in accordance with claim 24, wherein the cash deposit machine comprises a compartment configured to receive the amount in the different currency as a deposit in the cash deposit machine.
